(19) United States
(12) Patent Application Publication
(10) Pub. No.: US 2017/0265261 A1
(43) Pub. Date: Sep. 14, 2017

(54) SWITCHED MODE POWER CONVERTER CIRCUIT AND METHOD

(71) Applicant: PHILIPS LIGHTING HOLDING B.V., EINDHOVEN (NL)

(72) Inventors: DUO L. LI, EINDHOVEN (NL); DENNIS JOHANNES ANTONIUS CLAESSENS, EINDHOVEN (NL); HUI ZHANG, EINDHOVEN (NL); HONG JIANG, EINDHOVEN (NL)

(21) Appl. No.: 15/504,813

(22) PCT Filed: Aug. 14, 2015
(86) PCT No.: PCT/EP2015/068793

§ 371 Date: Feb. 17, 2017

(30) Foreign Application Priority Data
Aug. 19, 2014 (CN) PCT/CN2014/084740
Oct. 3, 2014 (CN) 14187665.6

(51) Int. Cl. H05B 33/08

(52) U.S. Cl. CPC H05B 33/0815

(57) ABSTRACT

A switched mode power converter circuit, comprising: an energy storing inductor (L1) coupled to the power supply and being charged by said power supply or discharge to power a load; a power switch (Q1) adapted to switch on and off to set said energy storing inductor to be charged or discharge; a further inductor (L2) coupled between a current output terminal of the power switch and a ground terminal, the further inductor being magnetically coupled with the energy storing inductor, wherein the further inductor is configured to apply a positive feed to the power switch as the energy storing inductor begins to be charged, thereby accelerating a switching on of the power switch; a sensing resistor (R3) coupled in series with the further inductor between the current output terminal of the power switch and the ground terminal; and a capacitor (C4) coupled between a control terminal of the power switch and the ground terminal, and between the power supply and the ground terminal.

### FIELD OF THE INVENTION

This invention is generally related to switched mode power converter circuit and methods for light emitting diode based lighting, and in particular which is compatible with variable input voltage based lighting technologies. The concept is not only used in led lighting, also can be used in other applications, such as industry power supply, consumer electronics, etc.

### BACKGROUND OF THE INVENTION

In this description and claims, the term “LED” will be used to denote both organic and inorganic light emitting diodes (LEDs), and the invention can be applied to both categories. LEDs are current driven lighting units. They are driven using an LED driver which delivers a desired current to the LED.

The required current to be supplied varies for different lighting units, and for different configurations of lighting unit. The latest LED drivers are designed to have sufficient flexibility that they can be used for a wide range of different lighting units, and for a range of numbers of lighting units.

Switched mode power supply circuits, such as buck converter circuits, are widely used as light emitting diode (LED) driver circuits and chargers because of their low cost. The switched mode power supply circuit employs a power or control switch to set or enable an energy storing inductor to be charged or discharged. The power or control switch is typically implemented by a MOSFET or similar technology transistor. However it is known that bipolar transistors and therefore bipolar transistor driver circuits are generally cheaper to implement than MOSFET transistor driver circuits. For low cost switched mode power supply circuits implementing the controllable switch within the converter as a bipolar transistor would be an improvement. However bipolar transistor switches are known to have limits with respect to switching frequency and effect frequency. These limits are a consequence of ‘regions’ of operation of a transistor switch. In a saturation ‘region’, when the bipolar transistor is fully switched on, the base of the bipolar transistor has ‘excess charge’ which is needed to be removed before the switching off of the transistor can be performed. This excess charge removal period creates a ‘storage time’ which limits the switching frequency and effect efficiency of the circuit.

Typically an additional circuit is required to control the base current of the bipolar transistor to speed up its turning off. An example of this is shown with respect to FIG. 1 which shows an emitter driver bipolar transistor configuration. The emitter driver circuit comprises a high voltage bipolar transistor Q1. The high voltage bipolar transistor Q1 is coupled to a first terminal of a potential or voltage supply Vb via a resistor Rb at the transistor Q1 base terminal. The emitter circuit further comprises a low voltage power MOSFET M1. The MOSFET M1 is coupled in cascade to the bipolar transistor Q1. The MOSFET is furthermore controlled by the gate G terminal input. In the example shown in FIG. 1 the MOSFET M1 is coupled to the emitter of the bipolar transistor Q1 and a second terminal of the voltage supply Vb.

The switching of the circuit is controlled by the MOSFET M1. When the MOSFET is switching on, the bipolar transistor is also on because the voltage source on the base of bipolar transistor delivers a base current. When the MOSFET is switching off, the bipolar is off because of the interruption of the emitter current. During the switching off of the bipolar transistor, the extra minority carriers in the base of the bipolar transistor are quickly evacuated or swept to the collector of the bipolar transistor. This evacuation or sweeping of the minority carriers lead to an improved turning-off process and allows higher switching frequencies.

Although not shown in FIG. 1, this configuration further requires circuitry to produce a stable voltage at the base of the bipolar transistor and also circuitry to produce a driver signal for the MOSFET transistor. In other words the emitter driver bipolar transistor configuration such as shown in FIG. 1 requires significant numbers of additional components over the simple bipolar switch.

WO 9811659A1 discloses a circuit that is a self-oscillating proportional drive converter. It comprises a winding connected to the base of the main switch to provide drive current proportional to the main switch current, and comprises a sense resistor in series with the main switch that activates a latch circuit to draws current from the base of the main switch to turn it off.

### SUMMARY OF THE INVENTION

Although improving the performance of bipolar driver circuits, the type of driver circuit such as described above is problematic with regards to cost sensitive applications as it requires either additional components or integrated circuit area. Additionally as both a bipolar transistor and a MOSFET are used in such a driver circuit it is arguable that the cost would not be much less and may be more than the known MOSFET driver circuits.

The above concerns are addressed by the invention as defined by the claims. A very basic idea of embodiments of the invention is connecting an auxiliary or AUX winding, magnetically coupled with a primary winding in the power path, to the current output terminal of the power switch. When the converter activates or switches on and the voltage on the primary winding changes, the AUX winding applies inductive voltage to the current output terminal of the power switch as feed and thus accelerates the power switch to activate or switch on.

According to an embodiment of the invention, there is provided a switched mode power converter circuit, comprising: an energy storing inductor coupled to a power supply and being charged by said power supply or discharge to power a load; a power switch adapted to switch on and off to set said energy storing inductor to be charged or discharged; a further inductor coupled between a current output terminal of the power switch and a ground terminal, the further inductor being magnetically coupled with the energy storing inductor, wherein the further inductor is configured to apply a positive feed to the power switch as the energy storing inductor begins to be charged, thereby accelerating a switching on of the power switch; a sensing resistor coupled in series with the further inductor between the current output terminal of the power switch and the ground terminal; and a capacitor coupled between a control terminal of the power switch and the ground terminal, and between the power supply and the ground terminal.

In such embodiments the positive feed to the power switch produces a faster or accelerated switching on of the bipolar transistor and therefore improves the performance of the driving circuit in terms of switching frequency and improved switching on of the bipolar transistor.

The positive feed may be a first voltage.

The sensing resistor may be configured to provide a second voltage to the current output terminal to counter the first voltage. The advantage of this embodiment is the sensing resistor provides a negative feedback to the power switch according to the power switch current, thus the current can be regulated and converge.

The capacitor may be configured to be charged during the switching on of the power switch and to further accelerate the switching on of the power switch. The advantage of this embodiment is the switching speed of the power speed is further increased.

The energy storing inductor may be configured to store energy within the inductor when the power switch is on and discharge stored energy when the power switch is off, the further inductor may be further configured to supply a negative feed to the power switch as the energy storing inductor discharges energy, thereby reinforcing a switching off of the power switch. The advantage of this embodiment is the off of the power switch is guaranteed and avoids leakage.

The negative feed may be a further voltage applied to the power switch.

The power switch may be a bipolar transistor, the current output terminal of the power switch may be an emitter of the bipolar transistor and the control terminal of the power switch may be a base terminal of the bipolar transistor.

The first voltage may be a negative voltage applied to the current output terminal of the power switch, where the power switch is a NPN bipolar transistor.

The first voltage may be a positive voltage applied to the current output terminal of the power switch, where the power switch is a PNP bipolar transistor.

The second voltage may be a positive voltage where the power switch is a NPN bipolar transistor, the second voltage may attract negative charge from the control terminal of the power switch to accelerate a switching off of the power switch.

The second voltage may be a negative voltage where the power switch is a PNP bipolar transistor, the second voltage may attract positive charge from the control terminal of the power switch to accelerate a switching off of the power switch.

The further voltage may be a positive voltage applied to the power switch where the power switch is a NPN bipolar transistor.

The further voltage may be a negative voltage applied to the power switch where the power switch is a PNP bipolar transistor.

The switched mode power converter may be a buck converter, the energy storing inductor may be coupled in serial between the power switch and a load, a freewheel diode may be coupled between the energy storing inductor and the load to freewheel the energy discharged from the energy storing inductor when the power switch is off, the capacitor may be coupled to the power supply via the load and a current limiting resistor.

The power switch may be an NPN transistor, and the further inductor may be coupled at an inflow or positive or dotted terminal to the emitter of the power switch and coupled at an outflow or negative terminal to a first terminal of the sensing resistor, the further inductor being magnetically coupled with the energy storing inductor such that the further inductor inflow terminal is proximate to the energy storing inductor outflow or negative terminal and the further inductor outflow terminal is proximate to the energy storing inductor inflow or positive or dotted terminal.

The switched mode power converter circuit may further comprise a discharging branch in parallel with said capacitor for allowing said capacitor discharge when the power switch is off.

The energy storing inductor may be coupled with the power switch and a light emitting diode assembly in such a way forming a Boost, Buck-boost or Flyback converter.

A lighting circuit may comprise: a switched mode power converter circuit as featured herein; and a light emitting diode arrangement coupled to the switched mode power converter circuit. In a further embodiment, the lighting circuit may further comprise a smoothing capacitor across the light emitting diode arrangement.

According to a second aspect there is provided method of driving current with a switched mode power converter circuit, the method comprising: coupling an energy storing inductor to a power supply, said energy storing inductor being charged by said power supply or being discharged to power a load; switching on and off a power switch to set said energy storing inductor to be charged or discharged; coupling a further inductor between a current output terminal of the power switch and a ground terminal; magnetically coupling the further inductor with the energy storing inductor, wherein the further inductor is configured to apply a positive feed to the power switch as the energy storing inductor begins to be charged, thereby accelerating a switching on of the power switch. In such embodiments the positive feed to the power switch produces a faster or accelerated switching on of the bipolar transistor and therefore improves the performance of the driving circuit in terms of switching frequency and improved switching on of the bipolar transistor.

The positive feed may be a first voltage.

The method may further comprise coupling a sensing resistor in series with the further inductor between the current output terminal of the power switch and the ground terminal. The method may comprise providing a second voltage to the current output terminal from the sensing resistor to counter the first voltage.

The method may further comprise coupling a capacitor between a control terminal of the power switch and the ground terminal, and between the power supply and the ground terminal. The method may comprise charging the capacitor during the switching on of the power switch and to further accelerate the switching on of the power switch.

The method may comprise storing energy within the inductor when the power switch is on and discharging stored energy when the power switch is off. The method further comprises supplying a negative feed from the further inductor to the power switch as the energy storing inductor discharges energy, thereby reinforcing a switching off of the power switch.

Supplying the negative feed may comprise applying a further voltage to the power switch.

The power switch may be a bipolar transistor, the current output terminal of the power switch may be an emitter of the bipolar transistor and the control terminal of the power switch may be a base terminal of the bipolar transistor.

Applying the first voltage may comprise applying a negative voltage to the current output terminal of the power switch, where the power switch is a NPN bipolar transistor.

Applying the first voltage may comprise applying a positive voltage to the current output terminal of the power switch, where the power switch is a PNP bipolar transistor.

Applying the second voltage may comprise applying a positive voltage where the power switch is a NPN bipolar transistor, in order that the second voltage may attract negative charge from the control terminal of the power switch to accelerate a switching off of the power switch.

Applying the second voltage may comprise applying a negative voltage where the power switch is a PNP bipolar transistor, in order that the second voltage may attract positive charge from the control terminal of the power switch to accelerate a switching off of the power switch.

Applying the further voltage may comprise applying a positive voltage to the power switch where the power switch is a NPN bipolar transistor.

Applying the further voltage may comprise applying a negative voltage to the power switch where the power switch is a PNP bipolar transistor.

The switched mode power converter may be a buck converter. The method may comprise coupling the energy storing inductor serially between the power switch and a load.

The method may comprise coupling a freewheel diode between the energy storing inductor and the load to freewheel the energy discharged from the energy storing inductor when the power switch is off. The method may comprise coupling the capacitor to the power supply via the load and a current limiting resistor.

The power switch may be an NPN transistor, and the method may comprise coupling the further inductor at an inflow or positive or dotted terminal to the emitter of the power switch and coupling the further inductor at an outflow or negative terminal to a first terminal of the sensing resistor. The method may comprise magnetically coupling the further inductor with the energy storing inductor such that the further inductor inflow terminal is proximate to the energy storing inductor outflow or negative terminal and the further inductor outflow terminal is proximate to the energy storing inductor inflow or positive or dotted terminal.

The method may comprise providing a discharging branch in parallel with said capacitor for allowing said capacitor to discharge when the power switch is off.

The method may comprise coupling the energy storing inductor with the power switch and a light emitting diode assembly to form one of: a Boost; a Buck-boost; or a Flyback converter.

These and other aspects of the invention will be apparent from and elucidated with reference to the embodiment(s) described hereinafter.

### BRIEF DESCRIPTION OF THE DRAWINGS

Examples of the invention will now be described in detail with reference to the accompanying drawings, in which:

FIG. 1 shows an example prior art LED driver circuit;

FIG. 2 shows an example LED driver circuit according to some embodiments; and

FIG. 3 shows an example LED driver circuit current waveforms.

### DETAILED DESCRIPTION OF THE EMBODIMENTS

The embodiments as described herein provide a switched mode power converter circuit for a driver circuit suitable for driving a light emitting diode arrangement. The driving circuit as described herein comprises an input for receiving an input power. The driving circuit comprises a switched mode power converter circuit configured to supply a driving current from the input. As described herein the switched mode power converter circuit comprises an energy storing inductor which is coupled to a power supply and may be configured to be charged by the power supply or to discharge to power a load such as the LED module. The driving circuit furthermore may comprise a controllable or power switch configured to control the switched mode power converter by being adapted to switch on and off to set the energy storing indictor to be charged or discharged.

The following description features a NPN bipolar transistor as an example power switch. Thus in the following description a control terminal of the power switch is a base of the transistor, the current input terminal of the power switch is the collector of the transistor and the current output terminal of the power switch is the emitter of the transistor. However it would be understood that any suitable power switch or element achieving the function of switching can be employed in some embodiments. For example the power switch in some embodiments is a PNP bipolar transistor rather than the NPN bipolar transistor described herein with appropriate differences in the circuit configuration.

The driver circuit may furthermore comprise a further or feed inductor coupled between a current output terminal of the power switch and a ground terminal. The further inductor may be magnetically coupled with the energy storing inductor. In other words the further inductor and the energy storing inductor are configured such that the magnetic field of the energy storing inductor can affect the further inductor. The further inductor may be configured as described herein to apply a positive feed to the power switch as the energy storing inductor begins to be charged. The positive feed may accelerate a switching on of the power switch.

The driver circuit may furthermore comprise a sensing resistor coupled in series with the further inductor between the current output terminal of the power switch and the ground terminal.

The driver circuit may also comprise a capacitor coupled between a control terminal of the power switch and the ground terminal, and further coupled between the power supply and the ground terminal.

The energy storing inductor may be configured to store energy within the inductor when the power switch is on and discharge stored energy when the power switch is off. The further or feed inductor may as described herein in further detail be further configured to supply a negative feed to the power switch as the energy storing inductor discharges energy, thereby reinforcing a switching off of the power switch. The negative feed may be a further voltage applied to the power switch.

In the examples described the positive feed may be a first voltage. The first voltage may be a negative voltage applied to the current output terminal of the power switch, where the power switch is a NPN bipolar transistor. Similarly the first voltage may be a positive voltage applied to the current output terminal of the power switch, where the power switch is a PNP bipolar transistor. The negative feed may be a second voltage. The second voltage may be a positive voltage where the power switch is a NPN bipolar transistor, the second voltage attracting any negative charges from the control terminal of the power switch to accelerate a switching off of the power switch. The second voltage may be a negative voltage where the power switch is a PNP bipolar transistor, the second voltage attracting positive charge from the control terminal of the power switch to accelerate a switching off of the power switch. The further voltage may be a positive voltage applied to the power switch where the power switch is a NPN bipolar transistor and may be a negative voltage applied to the power switch where the power switch is a PNP bipolar transistor.

It is appreciated that the switched mode power converter as described herein comprises a buck converter. However any suitable switched mode power converter circuit can be used using similar teaching as described herein. For example boost, buck-boost and flyback converters may implement the teachings described herein with respect to the buck converter.

FIG. 2 shows an example buck converter switched mode power converter circuit as implemented as part of a LED driver circuit. The example driver circuit comprises an alternating current (such as a 230V or 115V) supply V1 configured to provide at differential inputs 1, 3 which can be rectified (and filtered) to provide suitable high and low potential inputs to the switched mode power converter circuit. The alternating current supply may be a mains supply.

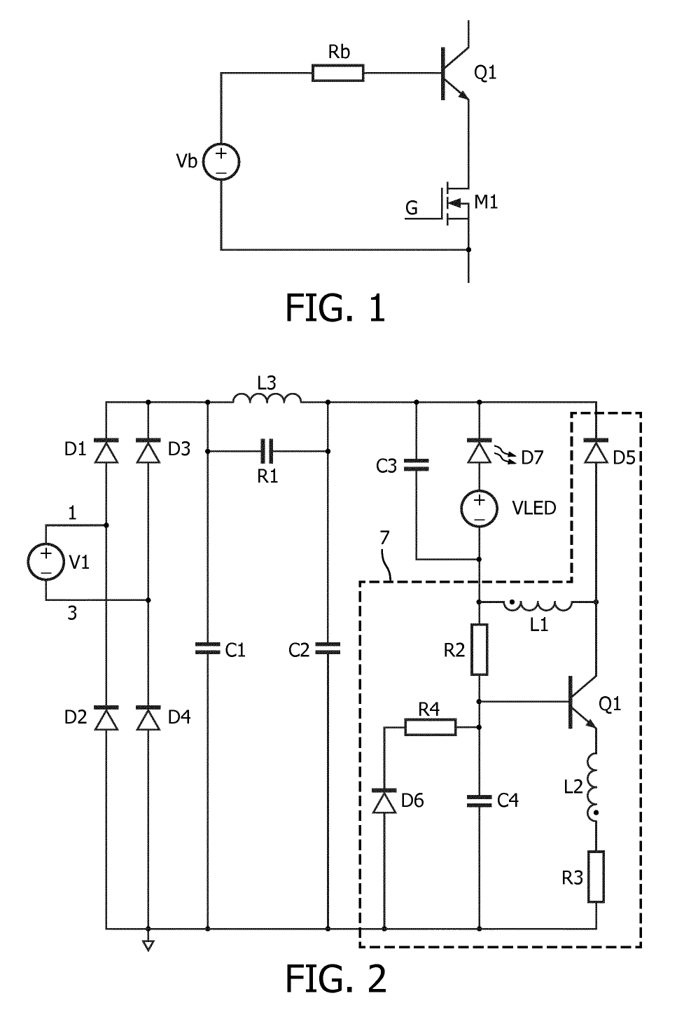

The alternating or mains supply may be rectified (and filtered) to form suitable high and low potential inputs (a rectified direct current or DC power also known as Vbus) coupled to the switched mode power converter circuit. In the example shown in FIG. 1 the example driver circuit implements the rectifier using a diode rectifier or bridge (D1, D2, D3, D4) which generates a full wave rectified output. FIG. 2 shows the first diode D1 with a cathode coupled to a first differential input 1 and an anode coupled to a first rectified output, a second diode D2 with a cathode coupled to a second rectified output and an anode coupled to the first differential input 1, a third diode D3 with a cathode coupled to a second differential input 3 and an anode coupled to a first rectified output, and a fourth diode D4 with a cathode coupled to a second rectified output and an anode coupled to the second differential input 3. However any other suitable rectifier or configuration may be employed.

Furthermore, in some embodiments the output of the rectifier may be filtered or buffered before being passed to the switched mode power converter. The filter or buffer as shown in FIG. 2 employs an input capacitor C1 coupled across the first and second rectified outputs from the diode rectifier. The input capacitor C1 in some embodiments is a 100 nF capacitor. The filter or buffer further comprises a filter inductor L3 coupled across the first rectified output from the diode rectifier and the high potential input (Vbus). The inductor L3 may be a 2.2 mH inductor. The filter further comprises a resistor R1 in parallel with the filter inductor L3, in other words coupled across the first rectified output from the diode rectifier and the high potential input (Vbus). The filter resistor R1 may be a 4.7 kΩ resistor. The filter may further comprise an output capacitor C2 coupled across the high potential input (Vbus) and the second rectified output from the diode rectifier. In some embodiments the second rectified output from the diode rectifier is coupled to ground or earth to form the low potential input to the switched mode power converter. The output capacitor C2 may be a 100 nF capacitor.

The driver circuit furthermore comprises a switched mode power converter, in this circuit being buck converter part 7 which converts the input power into a suitable driving current to power the LED, shown in FIG. 2 by D7. The switched mode power converter in some embodiments comprises a NPN bipolar transistor Q1 which is coupled and biased by a first network. The first network or discharging branch comprises a diode D6 and resistor R4 in series and coupled between the base of the transistor Q1 and the low potential input. In the example shown in FIG. 1 the resistor R4 is coupled between an anode of the diode D6 and the base of the transistor Q1, and the cathode of the diode D6 is coupled to the low potential input. The resistor R4 may be a 100Ω resistor and the diode D6 may be a 1N4148 diode.

The converter further comprises a startup capacitor C4. The startup capacitor C4 is coupled in parallel with the first network. In other words the startup capacitor C4 may be coupled between the base of the transistor Q1 and the low potential input. The startup capacitor C4 may be a 47 nF capacitor. The function of the startup capacitor C4, as defined by its name, is for starting up the transistor Q1, which will be discussed in detail later.

The converter may further comprise a startup resistor R2. The startup resistor R2 may be coupled between the between the base of the transistor Q1 and a LED module terminal. The startup resistor R2 may be a 100 kΩ resistor. Alternatively, the startup resistor R2 can be coupled to the filter or the buffer, namely coupled to the Vbus.

The converter may further comprise a load capacitor C3. The load capacitor may be coupled between the high potential input (Vbus) and the LED module terminal. The load capacitor C3 may be a 100 μF capacitor. The function of the load capacitor C3 is smoothing the power supplied to the LED D7.

The converter may further comprise the load or LED module which is coupled between the high potential input (Vbus) and the LED module terminal. In other words the load or LED module is coupled in parallel with the load capacitor C3. The load of LED module may comprise a series network of LED D7 with cathode coupled to the high potential input (Vbus) and the anode coupled to the LED voltage supply (Vled). The LED module may further comprise a LED voltage supply (Vled) coupled between the anode of the LED and the LED module terminal.

The converter may further comprise an energy storage inductor L1. The energy storage inductor L1 may be coupled between the LED module terminal and the collector (C) of the transistor Q1. The energy storage inductor L1 may be a 2.4 mH inductor.

The converter may further comprise a freewheel diode D5. The freewheel diode D5 may further be coupled between the high potential input (Vbus) and the collector (C) of the transistor Q1, where the diode anode is coupled to the high potential input. The freewheel diode D5 may be a UPSC600 diode.

The converter may further comprise a further or feed inductor L2 and a sensing resistor R3 in series coupled between the emitter of the transistor Q1 and the low potential input. The feed inductor L2 may be coupled between the emitter (E) of the transistor Q1 and a sensing resistor R3 first terminal. Where the bipolar transistor is a NPN transistor as shown in FIG. 1 then the feed inductor may have an inflow terminal coupled to the emitter of the transistor and an outflow terminal coupled to a first terminal of the sensing resistor. The sensing resistor may further be coupled between the feed inductor L2 and the low potential input. The feed inductor L2 may be a 3.3 μH inductor and may be magnetically coupled to the energy storage inductor L1 in such a manner that the feed inductor inflow terminal is proximate the energy storing inductor outflow terminal coupled to the LED module terminal and the feed inductor outflow terminal is proximate the energy storing inductor inflow terminal coupled to the collector of the transistor. The sensing resistor R3 may be 8.2Ω resistor.

The operation of converter as described is as follows.

The initial start-up of the converter is provided by the startup resistor R2. When the high potential input (Vbus) is higher than the LED voltage supple (Vled), a small current may flow through the startup resistor R2 to charge the startup capacitor C4. When the startup capacitor C4 is charged sufficiently to the threshold voltage of the bipolar transistor Q1, the bipolar transistor Q1 operates within the bipolar linear region. The switching on of the transistor in turn may enable a small current to pass through both the energy storage inductor L1 and the feed inductor L2.

Once a voltage across the energy storage inductor L1 is established, the magnetic coupling between the energy storage L1 and the feed inductor L2 creates a reflected voltage across the feed inductor L2. For the energy storage inductor L1 the dotted terminal is positive, and in turn for the feed inductor L2 the dotted terminal is positive. The feed inductor L2 may provide positive feed and act as a voltage source and provide a current spike through the startup capacitor C4 to the base of bipolar transistor Q1 and back to the feed inductor L2, namely in the clockwise direction, to make the bipolar enter a saturation region quickly. The smaller the capacitor value is, the shorter the spike duration will be. When the bipolar transistor is an NPN transistor the positive feed voltage may be a negative voltage applied to the current output terminal. Similarly when the bipolar transistor is a PNP transistor the positive feed voltage may be a positive voltage. In other words the startup capacitor C4 is charged as upper negative and lower positive, the initial current flows to the base of the transistor Q1, during the switching on of the power switch and to further accelerate the switching on of the power switch.

Furthermore a small current may pass through the flyback diode D6 and discharging branch resistor R4 to the base of Q1 to continue biasing Q1.

The current through the energy storage inductor L1 increases and the collector current of the bipolar transistor further increases. The emitter current may be defined as being equal to the sum of collector current and base current. The voltage of the startup capacitor C4 (V_{C4}) reaches a maximum value when the sum of the base current (ib) and the collector current (ic) is minimised. In other words Vc₄ is maximised when ib+ic is a minimum.

Furthermore as ib is smaller than ic, the voltage of the sensing resistor R3 (V_{R3}) is largely determined by ic. As ic increases, V_{R3} also increases, which causes the voltage of the startup capacitor V_{C4} to decrease and causes the startup capacitor C4 to discharge through the discharge branch of D6 and R4.

The increasing voltage across the sensing resistor V_{R3} may cause the voltage at the emitter of Q1 increase, causing the base current (ib) to reverse its direction. In other words the sensing resistor is configured to provide a negative feed (such as a positive voltage for a NPN bipolar transistor) to the current output terminal of the transistor to counter the positive feed from the feed inductor L2 (negative voltage). The negative feed (the positive voltage) may therefore attract negative charge from the control terminal of the power switch to accelerate a switching off of the power switch.

The reversing of the base current causes the bipolar transistor Q1 to start to leave the saturation region. Once the bipolar transistor Q1 re-enters the active region, the voltage between the collector and emitter of the bipolar transistor (Vce) increases while the collector current (ic) drops rapidly.

This rapid drop of collector current may cause the free-wheeling diode D6 to turn on and free-wheel the current through the energy storage inductor L1 after the collector current (ic) drops to zero. Furthermore the magnetic coupling between the energy storage inductor L1 and the feed inductor L2 creates a reflected voltage across the feed inductor L2. For the energy storage inductor L1 the dotted terminal is negative, and thus the dotted terminal of the feed inductor L2 is negative. The emitter E of the power switch Q1 has a high voltage potential. The feed inductor L2 thus may provide negative feed to further reinforce the switching off of the power switch. When the current through energy storage inductor L1 decreases to zero then the next cycle will start.

In such a manner the increasing bipolar transistor emitter voltage makes base current reverse its direction, which causes the extra minority carriers in base to be swept or extracted to the collector and therefore helps to decrease storage the time of the bipolar transistor.

In another way of explaining, as the base current increases, the emitter current increases and the voltage across the sensing resistor R3 increases. The voltage across R3 counters the base-emitter voltage Vbe across the transistor Q1 provided by the feed or AUX inductor L2. When the voltage across R3 gets to a certain amount, Vbe of Q1 decreases, there is no current flowing to the base, and the BJT Q1 moves from a saturation state to a cut-off state. The emitter current increases slowly, but the collector current keeps increasing because electrical charge in the base is drawn away from the base to the collector. Since the electrical charge is drawn, the storage time is decreased. Furthermore the startup capacitor C4 discharges through the discharge branch formed from D6 and R4.

At this time, the junction capacitor on the bipolar junction transistor (BJT) Q1 accumulates electrical charge and collector-emitter voltage Vce across the transistor Q1 increases. When the value of Vc increases to a certain amount, the BJT Q1 is off and the voltage across the main or primary or energy storage inductor (or winding) L1 is reversed, and D5 freewheels the current of the main winding. The auxiliary or feed inductor (or winding) L2 also reflects this voltage change, and makes the emitter voltage of the transistor higher than the base voltage of the transistor and thus reversely biases the BJT Q1, and makes sure the Q1 is off.

It is understood that this control method implemented on a bipolar transistor could be used convertors other than Buck converters. For example this method may be employed on bipolar transistors operating as power transistors in converters such as Boost, Buck-boost or Flyback converters. For example when used in Buck convertor, the current of the energy storage inductor L1 equals to LED current. The average current is furthermore just half of peak current. By controlling the peak current of inductor, the output LED current may be controlled to produce a suitable constant current control.

The proposed configuration and method topology therefore presents a new way to drive bipolar transistors through their emitter terminal instead of controlling the base terminal directly.

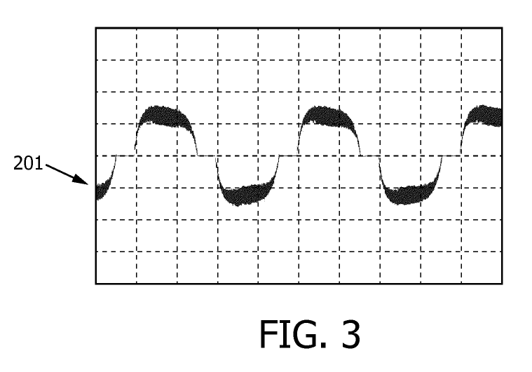

The voltage across the feed inductor L2 can be considered as a reference, because the power switching current form a counter voltage on the sensing resistor R3 to counter the voltage across the inductor L2. In the above configuration as the voltage across the feed inductor L2 and therefore the reference for the peak current is proportional to Vbus−Vled the input current/power switch current is shaped to follow the input voltage. The input-waveform shaping may result in a lower distortion of the line-current and in a higher power factor. It is understood that the final wave-form shape depends on the DC transfer function of the converter; however FIG. 3 shows an example input current wave-form 201 for a buck-topology.

While the invention has been illustrated and described in detail in the drawings and foregoing description, such illustration and description are to be considered illustrative or exemplary and not restrictive; the invention is not limited to the disclosed embodiments.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage. Any reference signs in the claims should not be construed as limiting the scope.

1. A switched mode power converter circuit, comprising:
an energy storing inductor coupled to the power supply and being charged by said power supply or discharge to power a load;
a power switch adapted to switch on and off to set said energy storing inductor to be charged or discharge;
a further inductor coupled between a current output terminal of the power switch and a ground terminal, the further inductor being magnetically coupled with the energy storing inductor, wherein the further inductor is configured to apply a positive feed to the power switch as the energy storing inductor begins to be charged, thereby accelerating a switching on of the power switch;
a sensing resistor coupled in series with the further inductor between the current output terminal of the power switch and the ground terminal; and
a capacitor coupled between a control terminal of the power switch and the ground terminal, and between the power supply and the ground terminal.

2. The switched mode power converter circuit as claimed in claim 1, wherein the energy storing inductor is configured to store energy within the inductor when the power switch is on and discharge stored energy when the power switch is off, the further inductor being further configured to supply a negative feed to the power switch as the energy storing inductor discharges energy, thereby reinforcing a switching off of the power switch.

3. The switched mode power converter circuit as claimed in claim 1, wherein the power switch is a bipolar transistor, the current output terminal of the power switch is an emitter of the bipolar transistor and the control terminal of the power switch is a base terminal of the bipolar transistor.

4. The switched mode power converter circuit as claimed in claim 1, wherein the switched mode power converter comprises a buck converter, the energy storing inductor is coupled in serial between the power switch and a load, a freewheel diode is coupled between the energy storing inductor and the load to freewheel the energy discharged from the energy storing inductor when the power switch is off,
the capacitor coupled to the power supply via the load and a current limiting resistor.

5. The switched mode power converter circuit as claimed in claim 3, wherein the power switch is an NPN transistor, and the further inductor is coupled at an inflow terminal to the emitter of the power switch and coupled at an outflow terminal to a first terminal of the sensing resistor, the further inductor being magnetically coupled with the energy storing inductor such that the further inductor inflow terminal is proximate to the energy storing inductor outflow terminal and the further inductor outflow terminal is proximate to the energy storing inductor inflow terminal.

6. The switched mode power converter circuit as claimed in claim 1, further comprising a discharging branch in parallel with said capacitor for allowing said capacitor discharge when the power switch is off.

7. The switched mode power converter circuit as claimed in claim 1, wherein the energy storing inductor is coupled with the power switch and a light emitting diode assembly in such a way that forming a Boost, Buck-boost or Flyback converter.

8. A lighting circuit, comprising:
a switched mode power converter circuit as claimed in claim 1; and
a light emitting diode arrangement coupled to the switched mode power converter circuit.

9. A method of driving current with a switched mode power converter circuit, the method comprising:
coupling an energy storing inductor to a power supply, said energy storing inductor being charged by said power supply or being discharged to power a load;
switching on and off a power switch to set said energy storing inductor to be charged or discharged;
coupling a further inductor between a current output terminal of the power switch and a ground terminal; magnetically coupling the further inductor with the energy storing inductor, wherein the further inductor is configured to apply a positive feed to the power switch as the energy storing inductor begins to be charged, thereby accelerating a switching on of the power switch;
coupling a sensing resistor in series with the further inductor between the current output terminal of the power switch and the ground terminal.
coupling a capacitor between a control terminal of the power switch and the ground terminal, and between the power supply and the ground terminal.

10. The method as claimed in claim 9, further comprising storing energy within the inductor when the power switch is on and discharging stored energy when the power switch is off; and supplying a negative feed from the further inductor to the power switch as the energy storing inductor discharges energy, thereby reinforcing a switching off of the power switch.

11. The method as claimed in claim 9, wherein the power switch is a bipolar transistor, the current output terminal of the power switch may be an emitter of the bipolar transistor and the control terminal of the power switch may be a base terminal of the bipolar transistor.

12. The method as claimed in claim 9, wherein the switched mode power converter circuit may be a buck converter, the method may further comprise:
coupling the energy storing inductor serially between the power switch and a load;
coupling a freewheel diode between the energy storing inductor and the load to freewheel the energy discharged from the energy storing inductor when the power switch is off; and
coupling the capacitor to the power supply via the load and a current limiting resistor.

13. The method as claimed in claim 11, wherein the power switch is an NPN transistor, and the method comprises:
coupling the further inductor at an inflow terminal to the emitter of the power switch and coupling the further inductor at an outflow terminal to a first terminal of the sensing resistor; and wherein
magnetically coupling the further inductor with the energy storing inductor further comprises locating the further inductor inflow terminal proximate to the energy storing inductor outflow terminal and locating the further inductor outflow terminal proximate to the energy storing inductor inflow terminal.

14. The method as claimed in claim 9, further comprising providing a discharging branch in parallel with said capacitor for allowing said capacitor to discharge when the power switch is off.

15. The method as claimed in claim 9, comprising coupling the energy storing inductor with the power switch and a light emitting diode assembly to form one of: a Boost; a Buck-boost; or a Flyback converter.
